(19) United States
(12) Patent Application Publication
(10) Pub. No.: US 2020/0156092 A1
(43) Pub. Date: May 21, 2020

(54) Painting Device and Painting Apparatus

(71) Applicant: CPR Group Australia Pty Ltd, Rydalmere (AU)

(72) Inventors: Mark Nicholas Smith, Rydalmere (AU); Rodrigo Hidalgo Canales, Gladesville (AU); Jordy Sven Rosbergen, IJssel (NL)

(73) Assignee: CPR Group Australia Pty Ltd, Rydalmere (AU)

(21) Appl. No.: 16/611,601

(22) PCT Filed: May 9, 2018
(86) PCT No.: PCT/AU2018/000067

§ 371 Date: Nov. 7, 2019

(30) Foreign Application Priority Data
May 9, 2017 (AU) 2017901718

(51) Int. Cl. B05B 1/28; B05B 9/01; B05B 9/00; B05D 1/02

(52) U.S. Cl. CPC B05B 1/28; B05D 1/02; B05B 9/007; B05B 9/01

(57) ABSTRACT

A painting device (10) for a paint sprayer (102) with a spray gun and a nozzle (110) connected to the spray gun. The painting device (10) comprises: a shroud (20) for shielding the nozzle of the paint sprayer, the shroud (20) having an inlet opening (22) for locating the nozzle in an interior of the shroud and an opposing outlet opening (24) for applying paint to a surface to be painted; and roller means (40, 42) mounted on or attached to the shroud (20), the roller means being configured to engage with the surface to be painted for supporting the shroud of the painting device for rolling movement over the surface with the outlet opening positioned substantially adjacent to the surface to be painted. The shroud (20) is configured for attachment of the paint sprayer (102) such that the spray gun connects to the nozzle (110) at or through the inlet opening (22) and the nozzle is fixed in the interior to substantially direct paint sprayed therefrom through the outlet opening (24). Also provided is a painting apparatus (100) comprising a painting device (10) and a paint sprayer (102). The shroud (20) of the painting device (10) is attached to the paint sprayer (102) such that the spray gun connects to the nozzle (110) through the inlet opening (22) and the nozzle (110) is fixed in the interior to substantially direct paint sprayed therefrom through the outlet opening (24).

### FIELD

The present invention relates to a painting device and a painting apparatus.

### BACKGROUND

Hand-held paint rollers are commonly used in painting surfaces. Generally, a hand-held paint roller comprises a handle, a frame extending from the handle to define a shaft, and a paint applicator rotatably attached to the shaft. The paint applicator is generally formed from a cylindrical core encased by a synthetic foam cover.

In one known method of painting, the paint applicator of a hand-held paint roller is dipped into paint contained in a tray. The paint applicator is then manually pressed and rolled against the tray to evenly absorb the paint. The paint applicator is then manually pressed and rolled against a surface to apply the paint. Although hand-held paint rollers can provide a consistent finish, the use of hand-held paint rollers is often very labour intensive and time consuming, especially when painting large surfaces. Also, paint can often drip from the paint applicator while painting and cause paint to be applied on undesired areas.

Paint sprayers, such as airless paint sprayers, are also commonly used in painting surfaces. Generally, a paint sprayer comprises a container of paint, a pressuriser to pressurise the paint, a spray gun to selectively release the pressurised paint and a nozzle connected to the spray gun to atomise the released paint into a spray.

In one known method of painting, the spray gun of a paint sprayer is manipulated so that the nozzle is aimed at a surface. Then, the spray gun is triggered to release the pressurised paint so that the paint is sprayed from the nozzle and applied to the surface. The spray gun is then continuously manipulated to direct the spray of paint across the entire surface. Paint sprayers allow paint to be accurately and quickly applied to a surface. However, there is a risk of over spray and splatter that can result in undesired areas being applied with paint. This risk is exacerbated in outdoor environment in which the spray of paint can be heavily affected by wind. Further, given that thinned paint is generally used in paint sprayers, there is an increased risk of drips and runs occurring after the paint has been applied to the surface.

### OBJECT OF INVENTION

It is an object of the present invention to provide a painting device that substantially overcomes, or at least ameliorates, one or more of the above disadvantages, or at least provides a useful alternative.

### SUMMARY OF INVENTION

In accordance with one aspect, the present invention provides a painting device for a paint sprayer having a spray gun and a nozzle connected to the spray gun, the painting device comprising:
a shroud for shielding the nozzle of the paint sprayer, the shroud having an inlet opening for locating the nozzle in an interior of the shroud and an opposing outlet opening for applying paint to a surface to be painted; and
roller means rotatably mounted or attached to the shroud such that the roller means are configured to engage with the surface to be painted for supporting the shroud of the painting device for rolling movement over the surface with the outlet opening positioned substantially adjacent to the surface to be painted,
wherein the shroud is configured for attachment of the paint sprayer such that the spray gun connects to the nozzle at or through the inlet opening and the nozzle is fixed in the interior to substantially direct paint sprayed therefrom through the outlet opening.

In a preferred embodiment, the shroud is configured to shield the paint sprayed from the nozzle from external influences, such as wind, and to confine the paint sprayed from the nozzle to an area defined by the outlet opening. To this end, the shroud preferably includes panels or walls which surround the interior and define the outlet opening adjacent to the surface to be painted. The panels or walls of the shroud operate to shield the nozzle and paint sprayed from the nozzle in the interior of the shroud from external influences, such as wind. In this way, the paint can be applied evenly and consistently to the surface even in variable outdoor conditions.

In a preferred embodiment, the roller means comprises one or more rollers attached to the shroud for rolling contact with the surface to be painted for supporting the painting device for rolling movement over that surface. In the context of the present invention, it will be noted that the roller means or the one or more rollers may comprise wheels or wheel sets, or spheres or balls configured or mounted to rotate about an axis. The roller means preferably comprises first and second rollers which may be attached or mounted on opposite sides of the shroud for stably and evenly supporting the shroud for movement on the surface to be painted. As skilled persons will understand, the axle or rotational axis of each roller typically will extend substantially perpendicular to a direction of movement of the painting device over the surface.

In a preferred embodiment, each of the first and second rollers or wheels or wheel sets is disposed at least partially, and more preferably substantially entirely, within the interior of the shroud and partially projects or extends through the outlet opening to engage the surface to be painted. In this way, the roller means (i.e. the first and second rollers or wheels) cooperate with the shroud to preset or predetermine a distance or spacing between the nozzle of the sprayer and the surface to be painted. This distance or spacing, together with the position and orientation of the nozzle, is desirably preset or predetermined to ensure the quality and consistency of the paint application.

In a preferred embodiment, each of the first and second rollers or wheels is configured as a paint roller for distributing and applying paint sprayed from the nozzle within the interior of the shroud to the surface to be painted. Thus, the first and second rollers are preferably arranged spaced apart from, and substantially parallel to, each other at opposite sides of the shroud. That is, they are arranged extending across the leading and trailing sides of the shroud, respectively, with respect to the direction of movement, as opposed to being at laterally opposite sides of the shroud. If the first and second rollers were embodied as wheels or wheel sets, however, (i.e. not configured for applying and distributing the paint), it is envisaged that they may preferably be arranged and/or mounted at lateral sides of the shroud.

In accordance with a preferred embodiment, therefore, the present invention provides a painting device for a paint sprayer having a spray gun and a nozzle connected to the spray gun, the painting device comprising:
a shroud having an interior with an inlet opening and an opposing outlet opening; and
first and second paint rollers rotatably attached to the shroud such that the first and second paint rollers are spaced apart from and substantially parallel to each other, the first and second paint rollers being configured to engage with a paintable surface such that the painting device is movable in relation to the paintable surface and the outlet opening is substantially adjacent to the paintable surface,
wherein the shroud is attachable to the paint sprayer such that the spray gun connects to the nozzle through the inlet opening and the nozzle is fixed in the interior to substantially direct paint sprayed therefrom through the outlet opening.

The first and second paint rollers may be substantially disposed in the interior and each of the first and second paint rollers partially extends through the outlet opening to engage the paintable surface. When the shroud is attached to the paint sprayer, the nozzle may substantially direct paint sprayed therefrom through the outlet opening between the first and second paint rollers.

In a preferred embodiment, the shroud comprises at least a front panel or front wall and a rear panel or rear wall with respect to the direction of rolling movement over the surface to be painted. More preferably, however, the shroud also includes lateral side walls which, together with the front and rear walls, surround or enclose the interior and define the outlet opening adjacent to the paintable surface. The outlet opening may, for example, be generally rectangular. The shroud may further include a top panel or wall from which the front and rear walls and or the side walls extend.

In a preferred embodiment, the shroud may comprise a plurality of inlet openings, each of which inlet openings is configured to receive and/or mount a respective nozzle of the paint sprayer. In this context, the paint sprayer comprises a corresponding plurality of nozzles. The inlet openings are preferably substantially evenly spaced apart from one another in a line or a row laterally across the shroud. In this way, the shroud is configured such that the paint may be introduced and applied to the surface to be painted from multiple nozzles simultaneously in a single painting device. By providing multiple nozzles spaced apart, the width of the shroud and, thus, the width of the band or strip of paint applied with the painting device, can be increased.

Thus, the shroud may comprise:
a top wall defining the at least one inlet opening;
a front wall extending forwardly from the top wall towards the outlet opening;
a rear wall extending rearwardly from the top wall towards the outlet opening; and
first and second side walls which interconnect the front and rear walls at opposite lateral sides of the shroud and extend from the top wall and towards the outlet opening.

The shroud may further comprise a pair of members for limiting pivotal movement of the spray gun in relation to the nozzle when the enclosure is attached to the paint sprayer, the members are spaced apart and extend from the top wall such that the inlet opening is disposed therebetween.

Each of the side walls may have a pair of apertures adjacent to the outlet opening, wherein each of the paint rollers comprises a spring-loaded member disposed on each end, and wherein the spring-loaded members of the paint rollers are respectively received in the apertures of the side walls for rotatable attachment.

Because the weight of the painting device can become a significant factor during prolonged periods of painting vertical surfaces, such as walls of buildings, or ceilings where the painting device is held up against the surface to be painted, a light-weight construction of the device is preferred. For this reason, relatively light-weight materials are preferably selected for the construction of the shroud. For example, the shroud may be formed from a rigid polymer material. Alternatively, the shroud may be formed from a fibre-reinforced polymer composite, such as carbon fibre composite.

As will be appreciated by persons skilled in the art, as paint rollers become fully soaked with paint they become significantly heavier. This becomes particularly apparent to operators who are using the rollers on elevated surfaces, such as high vertical walls and ceilings, because that weight needs to be supported overhead. The present invention therefore contemplates the painting device being provided with an extension pole, an end of which is for connection to the shroud such that an operator may hold and manipulate the painting device via the pole. Further, the invention also contemplates a belt or harness to be worn by the operator, where the belt or harness includes a recess or receptacle for receiving and supporting an opposite end of the pole. In this way, the operator may bear the weight of the shroud and the paint-soaked rollers via the belt or harness worn around the waist of the operator. This is considerably more comfortable and much less tiring than bearing the weight of the device via the operator's arms, especially when the arms are raised for work on elevated surfaces. The belt or harness is desirably formed of high-strength webbing or strap material.

In accordance with another aspect, the present invention provides a painting apparatus, comprising:
a paint sprayer comprising a spray gun and at least one nozzle connected to the spray gun; and
a painting device according to the invention as described above with reference to any one of the aspects or embodiments, wherein the shroud of the painting device is attached to the paint sprayer such that the spray gun connects to the nozzle through the inlet opening and the nozzle is fixed in the interior to substantially direct paint sprayed therefrom through the outlet opening.

The top wall of the shroud may be clamped between the nozzle and the spray gun for attachment.

The paint sprayer may be an airless paint sprayer.

In accordance with another aspect, the invention provides a method of painting a surface, such as a wall surface of a building, comprising:
providing a painting device comprising: a shroud for shielding a paint sprayer nozzle, the shroud having an inlet opening for connecting to the nozzle in an interior of the shroud and an opposing outlet opening for applying paint to a surface to be painted; and roller means mounted on or attached to the shroud such that the roller means are configured to engage with a surface to be painted for supporting the shroud for rolling movement over the surface to be painted with the outlet opening positioned substantially adjacent to the surface;
attaching a paint sprayer having a spray gun and a nozzle connected to the spray gun to the painting device such that is fixed in the interior of the shroud to direct paint sprayed therefrom through the outlet opening; and
activating the spray gun to spray paint through the nozzle of the sprayer shielded by the shroud while moving or rolling the painting device over the surface to be painted.

### BRIEF DESCRIPTION OF DRAWINGS

Preferred embodiments of the invention will be described hereinafter, by way of examples only, with reference to the accompanying drawings, in which:

FIG. 1 is an upper perspective view of an embodiment of a painting device;

FIG. 2 is a side view of the painting device of the FIG. 1;

FIG. 3 is a front view of the painting device of FIG. 1;

FIG. 4 is an underside view of the painting device of FIG. 1;

FIG. 5 is an underside perspective view of a shroud of the painting device of FIG. 1;

FIG. 6 is a side view of the shroud of FIG. 5;

FIG. 7 is a front view of the shroud of FIG. 5;

FIG. 8 is a top view of the shroud of FIG. 5;

FIG. 9 is an enlarged cross-sectional view of the attachment between one of the rollers of the painting device of FIG. 1 and the shroud of FIG. 5;

FIG. 10 is a side elevation of an embodiment of a painting apparatus comprising a painting device of FIG. 1 and a paint sprayer;

FIG. 11 is a plan view of the painting apparatus of FIG. 10;

FIG. 12 is a front elevation of the painting apparatus of FIG. 10 in use; and

FIG. 13 is an enlarged cross-sectional exploded view of the attachment between the painting device of the painting apparatus of FIG. 10 and the paint sprayer of the painting apparatus of FIG. 10.

### DESCRIPTION OF EMBODIMENTS

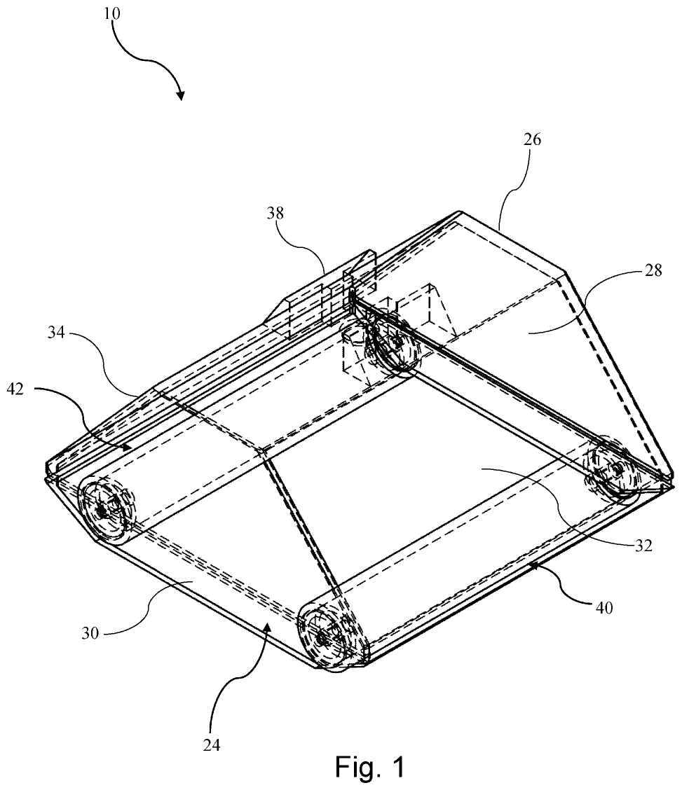

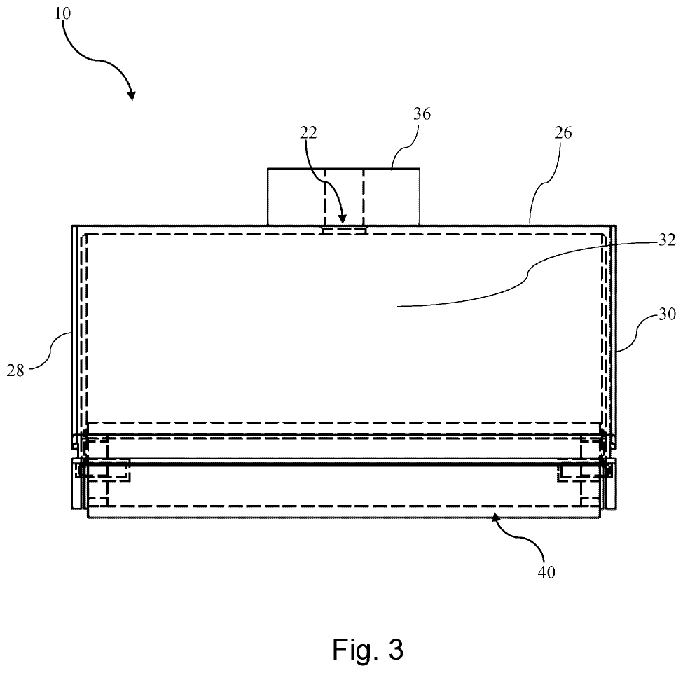

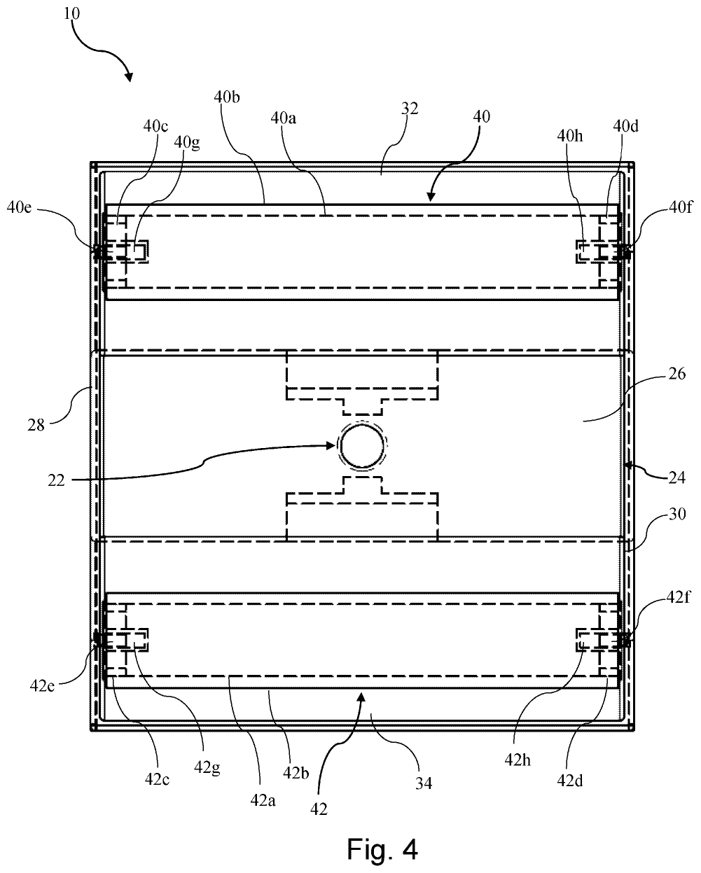

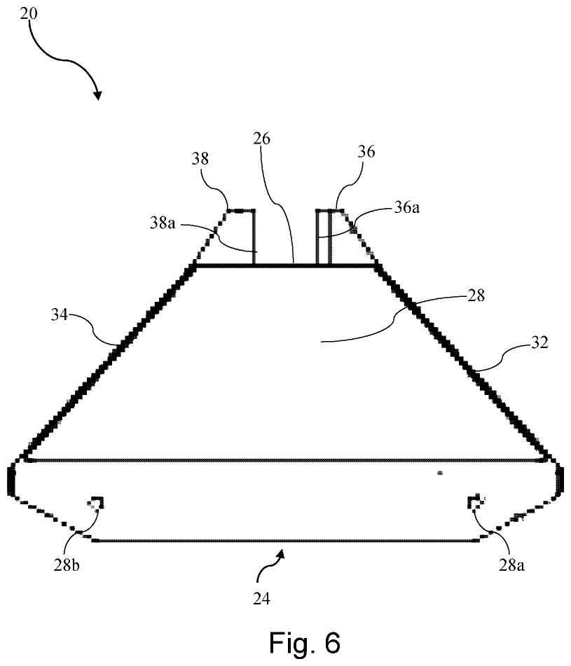

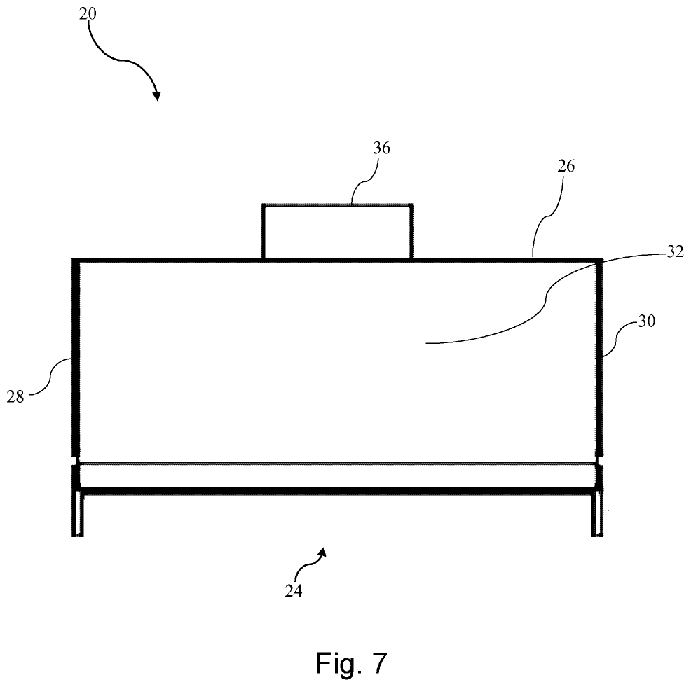

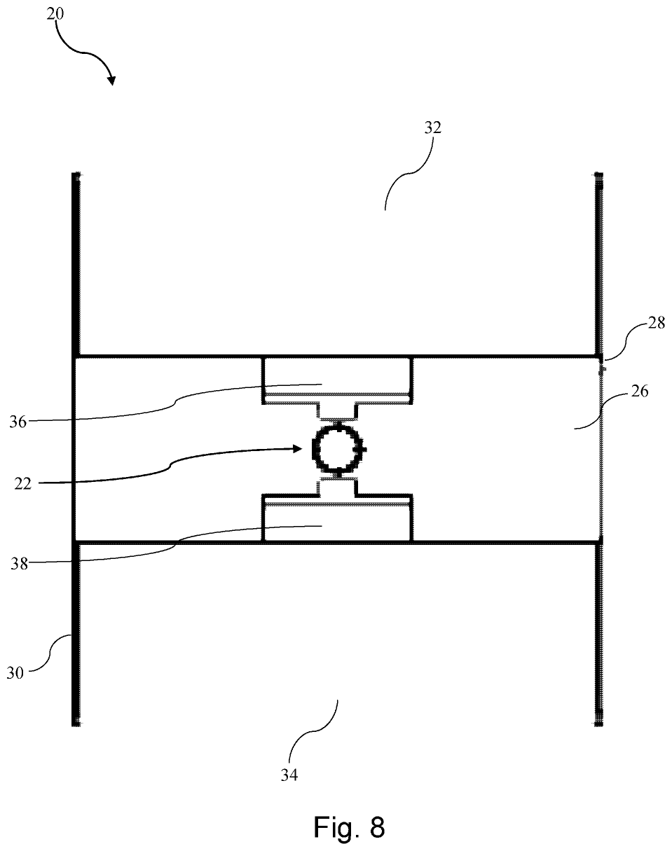

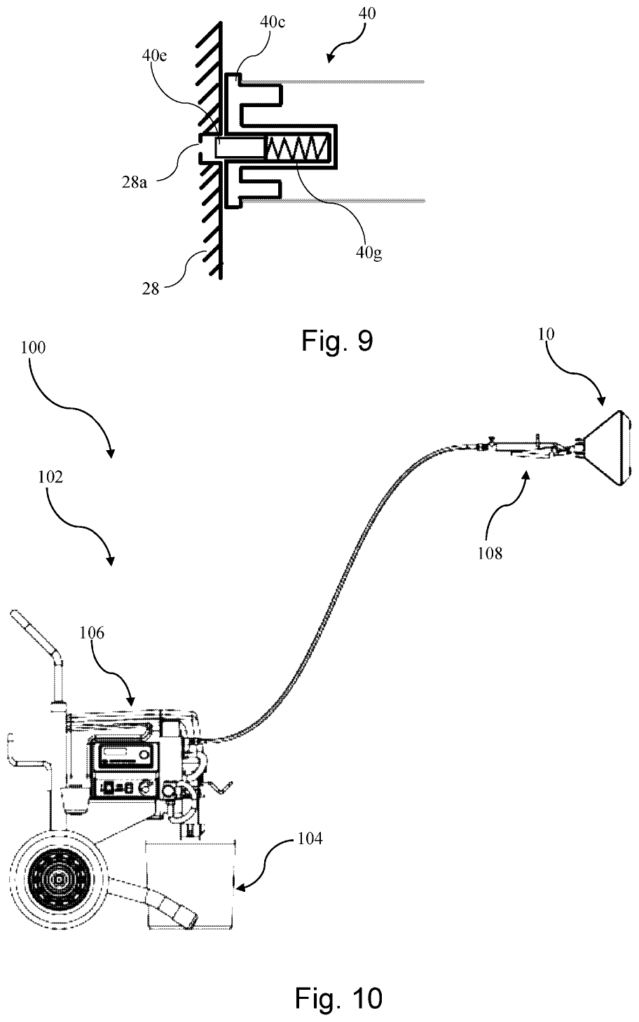

FIGS. 1 to 9 show an embodiment of a painting device 10. The painting device 10 comprises a shroud 20 formed from a carbon fibre composite. It will be appreciated that, in other embodiments, the shroud 20 may be formed from any other suitable rigid material, such as a rigid polymer.

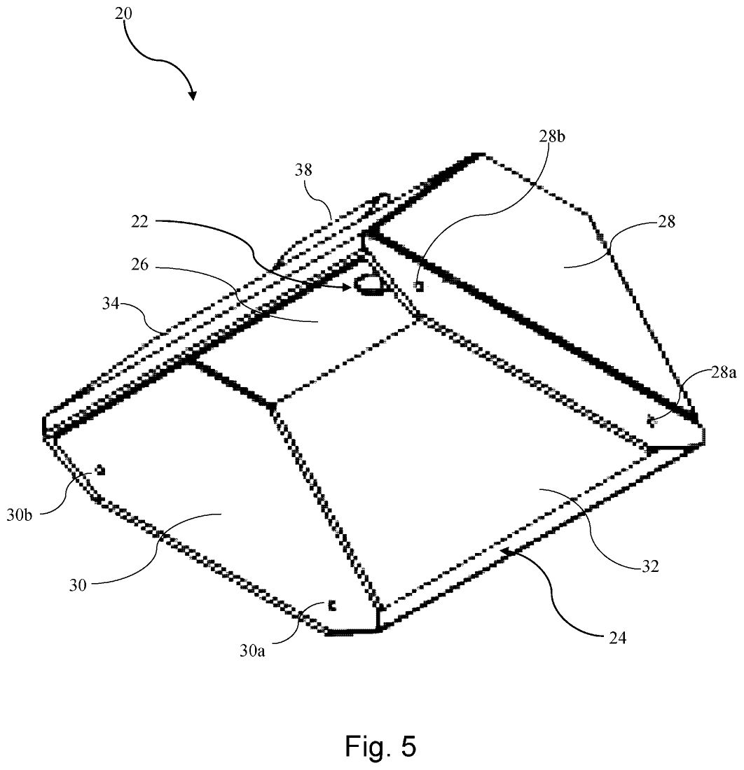

As best seen in FIGS. 5 to 8, the shroud 20 has an interior with an inlet opening 22 and an opposing outlet opening 24. The shroud 20 comprises a top wall 26, a pair of lateral side walls 28, 30, a front wall 32, and a rear wall 34. The top wall 26 is substantially planar and rectangular in shape defined by front and rear longitudinal sides, and right and left side ends. The top wall 26 has a central circular aperture which defines the inlet opening 22. Each of the lateral side walls 28, 30 is substantially planar and trapezoidal in shape. The side walls 28, 30 extend substantially parallel to each other. The side wall 28 extends downwardly from the left side end of the top wall 26 to the outlet opening 24. The side wall 30 extends downwardly from the right side end of the top wall 26 to the outlet opening 24. The side wall 28 has a pair of apertures 28a, 28b adjacent to the outlet opening 24. The side wall 30 has a pair of apertures 30a, 30b adjacent to the outlet opening 24. In the depicted embodiment, the aperture 28a is aligned with the aperture 30a and the aperture 28b is aligned with the aperture 30b. Each of the front and rear walls 32, 34 is substantially planar and rectangular in shape. The front wall 32 extends forwardly from the front longitudinal side of the top wall 26 to the outlet opening 24 and between the side walls 28, 30. The rear wall 34 extends rearwardly from the rear longitudinal side of the top wall 26 to the outlet opening 24 and between the side walls 28, 30. It will be noted that the terms “front” and “rear” and the terms “forwards” and “rearwards” (and variations thereof) are purely notional terms in the context of this embodiment, as the painting device 10 is adapted or designed to roll in both directions (i.e. both forwards and rearwards) over the surface to be painted and has the same appearance from the front and from the rear.

The shroud 20 further comprises a pair of triangular members 36, 38. The members 36, 38 are spaced apart and extend rearwardly from the top wall 26 such that the inlet opening 22 is located between the members 36, 38. In the depicted embodiment, the member 36 is disposed upward of the member 38. The member 36 has a surface 36a which is adjacent the inlet opening 22, and the member 38 has a surface 38a which is adjacent the inlet opening 22 and parallel to the surface 36a of the member 36.

As best seen in FIGS. 1 to 4, the painting device 10 further comprises first and second paint rollers 40, 42. The first paint roller 40 comprises a cylindrical hollow rigid core 40a and a roller cover 40b substantially encasing the core 40a. In the depicted embodiment, the core 40a is formed from a rigid polymer and the roller cover 40b is formed from synthetic foam. The first paint roller 40 further comprises a pair of end caps 40c, 40d. Each of the end caps 40c, 40d is attached to a respective end of the core 40a. The first paint roller 40 further comprises a pair of elongate members 40e, 40f. The elongate member 40e is attached to the end cap 40c such that the elongate member 40e is longitudinally movable. The elongate member 40e is biased outward from the end cap 40c by a spring 40g. The elongate member 40f is attached to the end cap 40d such that the elongate member 40f is longitudinally movable. The elongate member 40f is biased outward from the end cap 40d by a spring 40h.

The second paint roller 42 comprises a cylindrical hollow rigid core 42a and a roller cover 42b substantially encasing the core 42a. In the depicted embodiment, the core 42a is formed from a rigid polymer and the roller cover 42b is formed from synthetic foam. The second paint roller 42 further comprises a pair of end caps 42c, 42d. Each of the end caps 42c, 42d is attached to a respective end of the core 42a. The second paint roller 42 further comprises a pair of elongate members 42e, 42E The elongate member 42e is attached to the end cap 42c such that the elongate member 42e is longitudinally movable. The elongate member 42e is biased outward from the end cap 42c by a spring 42g. The elongate member 42f is attached to the end cap 42d such that the elongate member 42f is longitudinally movable. The elongate member 42f is biased outward from the end cap 42d by a spring 42h.

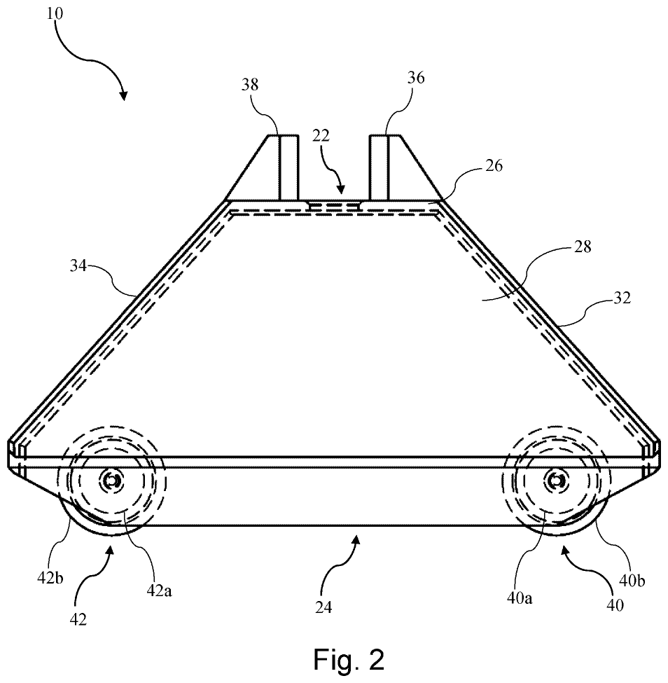

As best seen in FIGS. 2, 4 and 9, the first paint roller 40 is substantially disposed in the interior of the shroud 20 such that the elongate member 40e is received in the aperture 28a and the elongate member 40f is received in the aperture 30a. This attaches the first paint roller 40 to the shroud 20 and allows for rotation of the first paint roller 40 about an axis extending through the elongate members 40e, 40f. As best seen in FIG. 2, the first paint roller 40 partially extends through the outlet opening 24 such that a portion of the roller cover 40b is constantly exposed from the shroud 20 through the outlet opening 24.

The second paint roller 42 is substantially disposed in the interior such that the elongate member 42e is received in the aperture 28b and the elongate member 42f is received in the aperture 30b. This attaches the second paint roller 42 to the shroud 20 and allows for rotation of the second paint roller 42 about an axis extending through the elongate members 42e, 42f. As best seen in FIG. 2, the second paint roller 42 partially extends through the outlet opening 24 such that a portion of the roller cover 42b is constantly exposed from the shroud 20 through the outlet opening 24. In this depicted embodiment, the first paint roller 40 is spaced apart from and substantially parallel to the second paint roller 42.

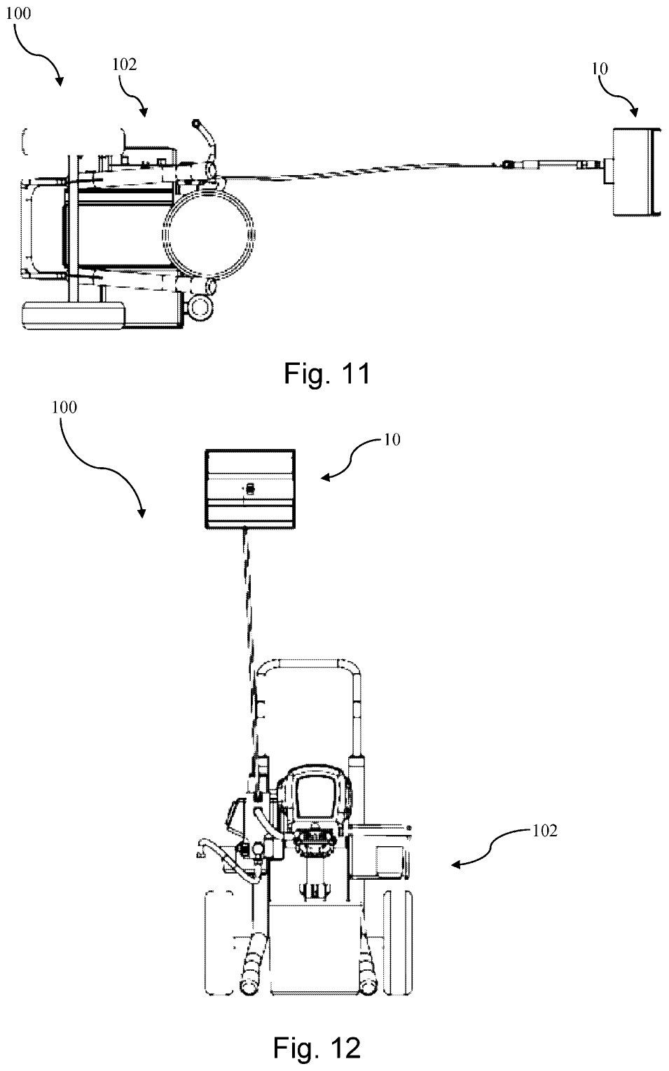

FIGS. 10 to 13 show an embodiment of a painting apparatus 100. The painting apparatus 100 comprises the painting device 10 and an airless paint sprayer 102. In the depicted embodiment, the airless paint sprayer 102 is the Ultra Max II 695 Electric Airless Sprayer from Graco®. The sprayer 102 comprises a container 104, a pressuriser 106, a spray gun 108 and a nozzle 110.

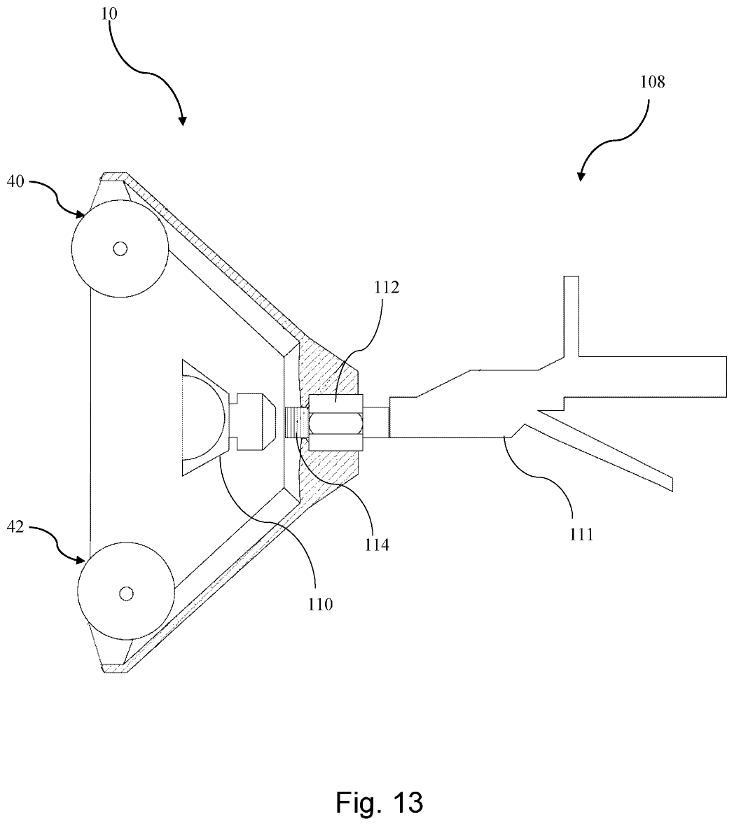

As best seen in FIG. 13, the spray gun 108 comprises an elongate body 111 with a trigger, a shoulder portion 112 pivotably attached to the body 111 and a threaded muzzle 114 extending from the shoulder portion 112. The threaded muzzle 114 is received through the inlet opening 22 of the shroud 20 of the painting device 10 such that the threaded muzzle 114 extends into the interior of the shroud 20 and the shoulder portion 112 abuts the top wall 26 of the shroud 20. The nozzle 110 is screwably connected to the threaded muzzle 114 such that the top wall 26 is clamped between the nozzle 110 and the shoulder portion 112. This attaches the shroud 20 to the paint sprayer 102 such that the nozzle 110 is fixed in the interior of the shroud 20 to direct any spray from the nozzle 110 through the outlet opening 24 and between the first and second paint rollers 40, 42.

An exemplary use of the painting apparatus 100 to paint a planar paintable surface will now be described. In this exemplary use, the paintable surface will be located in an outside or outdoor environment.

Initially, the pressuriser 106 of the painting apparatus 100 is activated by a user such that the paint in the container 104 is pressurised.

Next, the spray gun 108 is manipulated by the user to engage the rollers 40, 42 of the painting device 10 with the paintable surface. Specifically, the portions of the rollers covers 40b, 42b exposed from the shroud 20 will be pressed into contact with the paintable surface. This causes the outlet opening 24 to be substantially adjacent to the paintable surface without any part of the shroud 20 contacting the paintable surface. The nozzle 110 is thus positioned at a preset or predetermined distance or spacing from the surface to be painted, as well as at a preset or predetermined orientation with respect to the surface to be painted. Also, due to the rollers 40, 42, the painting device 10 is able to readily move along the paintable surface in a direction perpendicular to the axes of rotation of the rollers 40, 42.

Next, the user triggers the spray gun 108. This causes pressurised paint from the container 104 to be released through the nozzle 110 as a spray. Given the orientation of the nozzle 110, the spray is directed through the outlet opening 24 and applied to the paintable surface. It will be appreciated that the shroud 20 substantially covers the spray from the nozzle 110 to the paintable surface. This substantially prevents wind from affecting the trajectory of the spray. Also, given that the shroud 20 only exposes a certain area of the paintable surface through the outlet opening 24, the risk of the spray being accidently blown onto other undesired areas of the paintable surface is minimised.

Next, the user releases the trigger of the spray gun 108. Then, the user manipulates the spray gun 108 so that the painting device 10 moves along the paintable surface and the rollers 40, 42 roll and distribute the paint sprayed on the paintable surface. The user can continuously manipulate the spray gun 108 so that the painting device 10 moves back and forth over the paint sprayed on the paintable surface until the paint is evenly distributed. It will be appreciated, as the user manipulates the spray gun 108 to move the painting device 10, the body 111 of the spray gun 180 will pivot in respect of the shoulder portion 112 of the spray gun 108. However, the pivotal movement of the body 111 of the spray gun 108 is substantially limited when the body 111 abuts one of the triangular members 36, 38.

It will be appreciated that the above steps are repeated until the entire paintable surface is applied with paint.

According to the depicted embodiments, the painting device 10 allows paint to be sprayed to the paintable surface and then rolled in a relatively quick and efficient manner. Further, the painting device 10 substantially protects the spray of paint from the nozzle 110 of the paint sprayer 102 to the paintable surface. This allows the spray to be substantially unaffected by outside conditions, such as the wind, and limits the spray from being directed to undesired areas. Further, the rollers 40, 42 of the painting device 10 allow the paint to be evenly distributed for consistency after application by the paint sprayer 102. This provides a better finish on the paintable surface. Furthermore, as the paint is being sprayed by the painter sprayer 102, drips and splatter can be caught by the shroud 20 to substantially limit any mess. This is particularly useful when painting a ceiling.

Although the invention has been described with reference to a preferred embodiment, it will be appreciated by a person skilled in the art that the invention may be embodied in many other forms. It will be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the device, apparatus, system or method described herein is not limited to those features or parts or elements or steps recited but may include other elements, features, parts or steps not expressly listed or inherent to such device, apparatus, system or, method. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

1. A painting device for a paint sprayer with a spray gun and a nozzle connected to the spray gun, the painting device comprising:
a shroud for shielding the nozzle of the paint sprayer, the shroud having an inlet opening for locating the nozzle in an interior of the shroud and an opposing outlet opening for applying paint to a surface to be painted; and
roller means mounted on or attached to the shroud, the roller means being configured to engage with the surface to be painted for supporting the shroud of the painting device for rolling movement over the surface with the outlet opening positioned substantially adjacent to the surface to be painted,
wherein the shroud is configured for attachment of the paint sprayer such that the spray gun connects to the nozzle at or through the inlet opening and the nozzle is fixed in the interior to substantially direct paint sprayed therefrom through the outlet opening.

2. The painting device according to claim 1, wherein the shroud includes panels or walls which at least partially surround the interior and define the outlet opening adjacent to the surface to be painted, such that the shroud is configured to shield the nozzle and paint sprayed from the nozzle in the interior of the shroud from external influences.

3. The painting device according to claim 1, wherein the roller means comprises one or more rollers attached to the shroud for rolling contact with the surface to be painted for supporting the painting device for rolling movement over the surface to be painted.

4. The painting device according to claim 1, wherein the roller means cooperate with the shroud to preset or predetermine a distance or spacing between the nozzle of the sprayer and the surface to be painted.

5. The painting device according to claim 1, wherein the roller means comprises first and second rollers attached or mounted on opposite sides of the shroud for stably and evenly supporting the shroud for movement on the surface to be painted, wherein an axle or rotational axis of each roller extends substantially perpendicular to a direction of movement of the painting device over the surface.

6. The painting device according to claim 5, wherein each of the first and second rollers is configured as a paint roller for distributing and applying paint sprayed from the nozzle within the interior of the shroud to the surface, the first and second rollers arranged spaced apart from, and substantially parallel to, each other at opposite sides of the shroud.

7. A painting device for a paint sprayer having a spray gun and a nozzle connected to the spray gun, the painting device comprising:
a shroud having an interior with an inlet opening and an opposing outlet opening; and
first and second paint rollers rotatably attached to the shroud such that the first and second paint rollers are spaced apart from and substantially parallel to each other, the first and second paint rollers being configured to engage with a paintable surface such that the painting device is movable in relation to the paintable surface and the outlet opening is substantially adjacent to the paintable surface,
wherein the shroud is attachable to the paint sprayer such that the spray gun connects to the nozzle through the inlet opening and the nozzle is fixed in the interior to substantially direct paint sprayed therefrom through the outlet opening.

8. The painting device according to claim 6, wherein the first and second paint rollers are substantially disposed in the interior and each of the first and second paint rollers partially extends through the outlet opening to engage the surface.

9. The painting device according to claim 8, wherein, when the shroud is attached to the paint sprayer, the nozzle substantially directs paint sprayed therefrom through the outlet opening between the first and second paint rollers.

10. The painting device according to claim 1, wherein the shroud comprises:
a top wall defining the inlet opening;
a front wall extending forwardly from the top wall to the outlet opening;
a rear wall extending rearwardly from the top wall to the outlet opening; and
first and second side walls extending from lateral sides or lateral ends of the top wall to the outlet opening.

11. The painting device according to claim 10, wherein the shroud further comprises a pair of members for limiting pivotal movement of the spray gun in relation to the nozzle when the shroud is attached to the paint sprayer, the members are spaced apart and extend from the top wall such that the inlet opening is disposed therebetween.

12. The painting device according to claim 10, wherein each of the side walls has a pair of apertures adjacent to the outlet opening, wherein each of the paint rollers comprises a spring-loaded member disposed on each end, and wherein the spring-loaded members of the paint rollers are respectively received in the apertures of the side walls for rotatable attachment.

13. The painting device according to claim 1, wherein the shroud is formed from a rigid polymer material.

14. The painting device according to claim 1, wherein the shroud is formed from a fibre-reinforced polymer composite material, such as a glass fibre polymer composite or a carbon fibre polymer composite.

15. The painting device according to claim 1, wherein the shroud comprises a plurality of inlet openings, each of which inlet openings is configured to receive and/or mount a respective nozzle of the paint sprayer, wherein the inlet openings are preferably substantially evenly spaced apart from one another in a line or a row laterally across the shroud.

16. A painting apparatus, comprising:
a paint sprayer comprising a spray gun and a nozzle connected to the spray gun; and
a painting device according to claim 1, wherein the shroud of the painting device is attached to the paint sprayer such that the spray gun connects to the nozzle through the inlet opening and the nozzle is fixed in the interior to substantially direct paint sprayed therefrom through the outlet opening.

17. The painting apparatus according to claim 16, wherein the top wall of the shroud is clamped between the nozzle and the spray gun for and/or during attachment of the painting device to the paint sprayer, especially when the nozzle is connected to the spray gun via the inlet opening of the shroud.

18. The painting apparatus according to claim 16, wherein the paint sprayer is an airless paint sprayer.

19. A method of painting a surface, such as a wall surface of a building, comprising steps of:
providing a painting device comprising: a shroud for shielding a paint sprayer nozzle, the shroud having an inlet opening for locating the nozzle in an interior of the shroud and an opposing outlet opening for applying paint to a surface to be painted, and roller means mounted on or attached to the shroud such that the roller means are configured to engage with the surface to be painted for supporting the shroud for rolling movement over that surface with the outlet opening positioned substantially adjacent to the surface;
attaching a paint sprayer having a spray gun and a nozzle connected to the spray gun to the painting device such that is fixed in the interior of the shroud to direct paint sprayed therefrom through the outlet opening; and
activating the spray gun to spray paint through the nozzle of the sprayer shielded by the shroud while moving or rolling the painting device over the surface to be painted.

20. The method of claim 19, further comprising operating the shroud and roller means of the painting device via an extension pole supported on a belt or harness worn by an operator.
